(19) United States
(12) Patent Application Publication
(10) Pub. No.: US 2005/0021601 A1
(43) Pub. Date: Jan. 27, 2005

(54) Method, system and network element for addressing a cell related server

(76) Inventors: Fabio Longoni, Malaga (ES); Mattias Wahlqvist, Malaga (ES)

Correspondence Address: Robert M. Bauer;Brown Raysman Millstein Felder & Steiner, 900 Third Avenue, New York, NY, 10022, US

(21) Appl. No.: 10/486,509

(22) PCT Filed: Aug. 21, 2001
(86) PCT No.: PCT/EP01/09673

(51) Int. Cl. G06F 15/16

(52) U.S. Cl. 709/203

(57) ABSTRACT

The present invention relates to a method, system and network element for addressing a server related to a cell in a radio access network. A server identification identifying said server is added to a setup response message transmitted from a drift controller functionality to serving controller functionality. The server identification is then used at the serving controller functionality to derive the address of the server. Thus, the correct server can be addressed and dynamic network configurations can be allowed at reduced delay and processing requirements.

### FIELD OF THE INVENTION

The present invention relates to a method, system and network element for addressing a cell related server in a radio access network (RAN), such as a UTRAN (UMTS Terrestrial RAN), a GERAN (GSM EDGE RAN), an IP (Internet Protocol) related RAN or any other cellular RAN.

### BACKGROUND OF THE INVENTION

As the Internet has grown in popularity and mobile Internet for text-based information and picture messaging is already a reality, the industry has turned its focus on engineering the most cost efficient network for more demanding multimedia services. IP-based networks are considered by many the best way forward and networking technology research and development is by and large centered around IP-technologies.

The development of an IP-based radio access network will bring together a number of radio access network technologies including second generation (2G), third generation (3G) and Wireless Local Area Networks (WLANs). Network operators are shifting from a circuit-switched to a packet-switched technology, while IP-based networks need to expand radio access rapidly, flexibly and cost efficiently.

IP-based radio access networks can be introduced as a smooth evolution from existing GSM (Global System for Mobile communications), EDGE (Enhanced Data Rates for GSM Evolution) and WCDMA (Wideband Code Division Multiple Access) networks. Key benefits of such IP-based radio access networks are distributed architecture with a separation of user and control planes (offering infinite scalability and no bottlenecks), integration of different radio interface technologies into a single radio access network, common radio resource management for optimum use of radio resources, quality of service (QoS) control, and network automaton, open interfaces for multi-vendor networks, and compatibility to existing transmission networks.

In such new radio access networks the standardisation body (i.e. 3GPP (3rd Generation Partnership Project)) is introducing some control plane ‘servers’ that have RAN only functions, e.g. a Serving mobile Location Centre (SMLC) for performing the positioning functions for the mobile station (MS) or user equipment (UE) in the radio access network, and a Common Radio Resource Manager (CRRM) or Common Resource Manager Server (CRMS) for performing radio resource management algorithms based on dynamic status information of cells that do not belong to the same base transceiver station (BTS) or radio network controller (RNC). The SMLC and CRMS are associated to a certain area, where they have the control of a location measurement unit and the radio resource of the cells, respectively.

A Serving RNC (SRNC) controlling a UE may use the SMLC for the calculation of the position of the UE, or the CRRM for the prioritisation of the handover target cell(s) to be performed by the UE (or any other operation affecting the radio resources used by the UE). In doing so, the SRNC need to contact the SMLC and CRMS associated to the cell(s) used by the UE. However, the UE may use cells that are not controlled by the SRNC. This is the case if a cell used by the UE is controlled by a Drift RNC (DRNC) which is any RNC, other than the SRNC, that controls cells used by the UE by providing only resources and radio layer 1 (L1) functions for the UE connection so as to route data transparently between the interface (e.g. lu interface) connecting the radio access network to a core network (CN) and the interface (e.g. lur interface) connecting the DRNC to the SRNC. It is noted that one SRNC may use any of the other RNCs as DRNC.

Thus, if the SRNC wishes to contact the SMLC or the CRMS associated or related to the current cell used by the UE (e.g. for mobile location, for prioritisation of the handover candidate, or other related operations), the problem arises that the address of the CRMS or SMLC controlling the drift cell Is not available at the SRNC.

This problem is unknown, since such common servers (CRMS and SMLC) are not yet specified in 3GPP. Discussion on the SMLC standardisation has been up to now focused on a positioning method that does not require the SMLC to receive measurement from the location measurement unit (LMU), thus without facing this problem.

This problem may be solved by pre-configuring the CRMSs and/or SMLCs controlling each own and each possible drift cell (or each possible drift RNC) in the RNC. However, this requires a configuration table which is difficult to manage and reconfigure when the network configuration is changed. Alternatively, the problem may be solved in that the SRNC sends the request for service (location, handover candidate) to a (or one of) predefined SMLC/CRMS, that takes care of forwarding the data to the relevant CRMS/SMLC. Nevertheless, a configuration table defining the predefined CRMS(s)/SMLC(s) is still required. Finally, the SRNC may forward the location/handover priority to the DRNC via the lur interface. The DRNC is then using the SMLC and the CRMS for the evaluation. However, this leads to delay and extra processing of the DRNC and thus to a reduced Quality of Service (QoS).

The problem was described above for a UTRAN environment. In the IP-RAN environment the problem is even bigger since the number of IP-BTSs (IP-Base Transceiver Stations) is greater than the number of RNCs. In IP-RAN, the IP-BTS acts in many aspects like an RNC, so that the number of Drift-BTSs (DBTSs) may become very large.

### SUMMARY OF THE INVENTION

It is therefore an object of the present invention to provide an addressing procedure by means of which the correct server in the radio access network can be addressed, especially in case the connection is handled by one or more DRNCs or DBTSs.

This object is achieved by a method for addressing a server related to a cell in a radio access network, said method comprising the steps of:
initiating a setup between a serving controller functionality in charge of controlling a mobile terminal located in said cell, and a drift controller functionality in charge of controlling said cell;
adding a server identification identifying said server to a setup response message transmitted from said drift controller functionality to said serving controller functionality; and
using said server identification at said serving controller functionality to derive the address of said server.

Furthermore, the above object is achieved by a system for addressing a server related to a cell in a radio access network, said system comprising:
a serving controller functionality in charge of controlling a mobile terminal located in said cell, for initiating a setup to a drift controller functionality in charge of controlling said cell;
wherein said drift controller functionality is arranged to add a server identification identifying said server to a setup response message transmitted to said serving controller functionality; and
wherein said serving controller functionality is arranged to use said server identification to derive the address of said server.

Additionally, the above object is achieved by a network element for addressing a server related to a cell in a radio access network, said network element comprising:
signaling means for initiating a setup procedure to a drift controller functionality in charge of controlling said cell; and
address generating means for deriving the address of said server from a response message received from said drift controller functionality.

In addition thereto, the above object is achieved by a network element having a drift controller functionality in charge of controlling a cell in a radio access network, comprising:
means for adding a server identification of a server, related to said cell, to a setup response message in response to the receipt of a setup request; and
means for transmitting said response message to a serving controller functionality from which said setup request has been received.

Accordingly, the correct server is always addressed based on the server identification given in the response message received from the drift controller functionality. A configuration table and the associated difficulty to manage and reconfigure it when the configuration of the network is changed can thus be avoided. Furthermore, dynamic configurations, fault resilience, etc. are allowed.

Due to the fact that the serving controller can directly contact the server (SMLC/CRMS), delay and extra processing at the drift cell can be avoided.

The setup may be initiated by an lur user plane setup procedure. It may comprise a common transport channel resources initialization, a radio link setup procedure, or a radio link addition procedure. Preferably, the setup procedure is selected according to an operating state of the mobile terminal. The response message may be a common channel setup response, a radio link setup response, or a radio link addition response.

The server identification may comprise an identifier or signaling address of the server. Alternatively, the server identification may comprise an SCCP address, an identification assigned by the network operator, a DNS address or identification, or an IP address and port number, based on which the address of the server is derived.

The server identification may comprise also several identifiers or signaling addresses of the server. Alternatively, the server identification may comprise SCCP addresses, identifications assigned by the network operator, DNS addresses or identifications, or IP addresses and port numbers, based on which the address of the servers is derived. In this case, the network element having a serving controller functionality may choose which server to use.

If a soft handover is performed, the server identification may either be used to derive the addresses of two servers each controlling a respective cell if a soft handover between the respective cells of said servers is performed, or the server identification may be used to derive the address of a server to be used for the setup connection. The network element having a serving controller functionality may choose which server to use. Alternatively, the drift controller functionality may choose which server should be used. In this case, the drift controller functionality may send only the chosen server identification to the serving controller functionality.

Preferably, the serving controller functionality and the drift controller functionality is provided in a corresponding radio network controller or base transceiver station.

Furthermore, the drift controller functionality may be arranged to return its own address or no address, if it is provided in a network element having also the function of the cell related server.

According to a advantageous modification, the drift controller functionality may be arranged to add more than one server identification to the response message, and the serving controller functionality may be arranged to select one server identification.

According to another advantageous modification, the server may be associated to a controller functionality of said radio access network.

In particular, the server may comprise a common radio resource management functionality and/or a common position calculation functionality.

### BRIEF DESCRIPTION OF THE DRAWINGS

In the following, the present invention will be described in greater detail based on preferred embodiments with reference to the accompanying drawings in which:

FIG. 1 shows a basic architecture of a radio access network in which the present application can be implemented; and

FIG. 2 shows a signaling diagram corresponding to the addressing procedure of according to the preferred embodiment.

### DESCRIPTION OF THE PREFERRED EMBODIMENTS

The preferred embodiment will now be described using the UTRAN terminology. However, the following description is valid for any cellular radio access network with the following change of notation. The described RNC may be replaced by any radio resource controller functionality, such as an IP BTS, the SRNC may be replaced by any controller functionality, such as a serving IP BTS, in charge of controllling a mobile terminal, the DRNC may be replaced by any controller functionality, such as a Drift IP BTS, in charge of controlling a cell, the SMLC may be replaced by any kind of server for position calculating, and the CRRM/CRMS may be replaced by any kind of server for handover prioritization or the like.

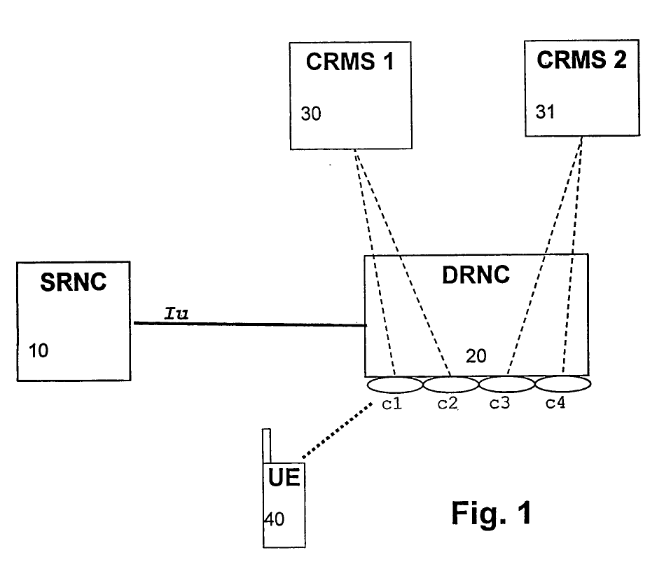

In FIG. 1, a radio access network architecture is shown, where a UE 40, e.g. a mobile terminal or any other radio-connected terminal device, is connected via a base station or node B (not shown) of a first cell c1 to a DRNC 20 in charge of controlling radio resources in four cells c1 to c4. An SRNC 10 in charge of controlling the core network interface (i.e. lu interface) and of terminating the radio resource control (RRC) for the UE 40 is connected to the DRNC 20 via an lur user plane connection. In the configuration shown in FIG. 1, a first CRMS 30 is related to the first cell c1 and a second cell c2, and a second CRMS 31 is related to a third cell c3 and a fourth cell c4. It is noted that, although two CRMSs are shown in this example, there do not have to be provided many CRMSs which are related to one DRNC.

When the lur user plane connection is setup between the SRNC 10 that controls the UE 40 and the DRNC 20 that control the cells c1 to c4, the DRNC 20 returns to the SRNC 10 the address of the SMLC and/or CRMS, e.g. the first CRMS 30 or the second CRMS 31, in charge of controlling the area where the drift-cell (cell under control of the DRNC 20 used by the UE 40). The address may be included in the ‘response’ of the lur user plane setup procedure, e.g. the Radio Link Setup Response, the Radio Link Addition Response, the Common Channel Setup Response or any other suitable response message of the setup procedure. A detailed description of the lur setup procedure can be gathered from the current 3GPP specification TS 25.423 of the lur signalling protocol of the Radio Network Subsystem Application Part (RNSAP).

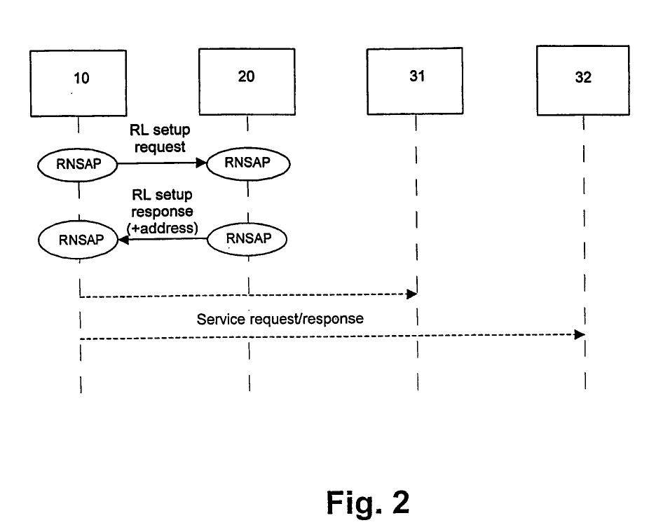

FIG. 2 shows a signaling diagram indicating a RNSAP signaling Initiated by the SRNC 10 to obtain the server address of the first or second CRMS 30, 31.

The setup of the first radio link to the DRNC 20 may be done by using one of the following procedures. A common transport channel resources initialization may be performed towards the DRNC 20 using an RACH/FACH (Random Access Channel/Forward Access Channel), if the UE 40 is in the common channel state. Alternatively, as indicated in FIG. 2, a Radio Link (RL) Setup may be initiated by transmitting a RL setup request to the DRNC 20, when the UE 40 is in the dedicated state and the drift cell, i.e. the fist cell c1, is the first one used in that DRNC 20. As another alternative, a Radio Link Addition procedure may be initiated by the SRNC 10, when the UE 40 is in the dedicated state and the drift cell c1 is not the first one used in that DRNC 10.

Then, the DRNC 20 is arranged to add or include in the response messages of those procedures (e.g. common transport channel resource response message, Radio Link setup Response message (as indicated in FIG. 2), Radio Link addition response message or any other suitable response message) identifiers or signalling addresses of the CRMS (e.g. the first and/or second CRMS 30, 31) and/or SMLC in charge of controlling the drift cell c1.

Based on the received identifiers or signaling addresses, the SRNC 10 may now transmit a service request or response (e.g. a handover candidate prioritization) to the associated CRMS, using any suitable signaling, e.g. a RAN Application Part (RANAP) signaling.

The DRNC 20 may as well return other information that allows the SRNC 10 to obtain the address of the server. E.g., the Signaling Connection Control Part (SCCP) address (like Global Title), an identification (ID) assign by the network operator, a DNS (Domain Name Server) address or identification, an IP Address and port number, or the like.

Furthermore, the DRNC 20 may return its own address (or nothing) in case it has incorporated the function of the SMLC and CRMS (which are optional network elements), or in case it wants to receive the service request itself, for any reason.

If the DRNC 20 has more than one CRMS/SMLC associated to the drift cell c1, it may select one case by case (for load sharing, fault resilience, etc.) or it may return more than one address for CRMS and/or SMLC, and the SRNC 10 may select which one to use.

In case the CRMS/SMLC are associated to controllers (RNC) instead of cells (more simplified architecture), the addresses or IDs in the RL Addition Response Message are not needed since the SRNC 10 has already received those IDs or addresses when the first radio link in the DRNC 20 was setup with the RL Setup procedure.

In case of a soft handover in the DRNC 20 (which corresponds to an RL Addition), the two handover cells in the DRNC 20 may be associated to two different servers. Then, the DRNC 20 may either return the ID or address of the servers controlling both the cells, or only one ID or address of the server to be used for that connection.

As already mentioned, the present invention can be implemented in any radio access network and is not restricted to the specific elements of the radio access network according to the preferred embodiments. The invention can be generalised to other ‘servers’ which may be introduced in future cellular radio access networks. The names of various functional entities, such as the RNC, BSC and the BTS, may be different in different cellular networks. The names used in the context of the preferred embodiments are not intended to limit or restrict the invention. In general any logical interface between two network elements in charge of controlling the use and integrity of radio resources can be used instead of the described lur interface. Moreover, any interconnection between a network element in charge of controlling the use and integrity of the radio resources and a core network can be used instead of the lu interface. The described drift network element may be any network element supporting a serving network element with radio resources when the connection between the radio access network and the user equipment need to use cells controlled by this network element. The serving network element may be any network element terminating the core network interface and being in charge of radio resource control connection between a user equipment and the radio access network. The preferred embodiments may thus vary within the scope of the attached claims.

1. A method for addressing a server related to a cell in a radio access network, said method comprising the steps of:
initiating a setup between a serving controller functionality in charge of controlling a mobile terminal located in said cell, and a drift controller functionality in charge of controlling said cell;
adding a server identification identifying said server to a setup response message transmitted from said drift controller functionality to said serving controller functionality; and
using said server identification at said serving controller functionality (10) to derive the address of said server.

2. A method according to claim 1, wherein said setup is initiated by an lur user plane setup procedure.

3. A method according to claim 2, wherein said setup procedure comprises a common transport channel resources initialization, a radio link setup procedure, or a radio link addition procedure.

4. A method according to claim 1, wherein said setup procedure is selected according to an operating state of said mobile terminal.

5. A method according to claim 1, wherein said response message is a common channel setup response, a radio link setup response, or a radio link addition response.

6. A method according to claim 1, wherein said server identification comprises an identifier or signaling address of said server.

7. A-method according-to any one of claims 1, wherein said server identification comprises at least one SCCP address, identification assigned by the network operator, DNS address or identification, or IP address and port number, based on which said address of said server is derived.

8. A method according to claim 1, wherein said server identification is used to derive the addresses of two servers each controlling a respective cell.

9. A method according to any one of claims 1, wherein said server identification is used to derive the address of a server to be used for the setup connection if a soft handover is performed.

10. A system for addressing a server related to a cell in a radio access network, said system comprising:
a serving controller functionality in charge of controlling a mobile terminal located in said cell, for initiating a setup to a drift controller functionality in charge of controlling said cell;
wherein said drift controller functionality is arranged to add a server identification identifying said server to a setup response message transmitted to said serving controller functionality; and
wherein said serving controller functionality is arranged to use said server identification to derive the address of said server.

11. A system according to claim 10, wherein said serving controller functionality and said drift controller functionality is provided in a corresponding radio network controller or base transceiver station or base station controller.

12. A system according to claim 10, wherein said drift controller functionality is arranged to return its own address or no address, if it is provided in a network element having also the function of said cell related server.

13. A system according to claim 10, wherein said drift controller functionality is arranged to add more than one server identification to said response message, and said serving controller functionality is arranged to select one server identification.

14. A system according to claim 10, wherein said server is associated to a controller functionality of said radio access network.

15. A system according to claim 10, wherein said server comprises a common radio resource management functionality and/or a common position calculation functionality.

16. A network element for addressing a server related to a cell in a radio access network, said network element comprising:
signaling means for initiating a setup procedure to a drift controller functionality in charge of controlling said cell; and
address generating means for deriving the address of said server from a response message received from said drift controller functionality.

17. A network element according to claim 16, wherein said network element is a base transceiver station or a radio network controller or base station controller.

18. A network element having a drift controller functionality in charge of controlling a cell in a radio access network, comprising:
means for adding a server identification of a server, related to said cell, to a setup response message in response to the receipt of a setup request; and
means for transmitting said response message to a serving controller functionality from which said setup request has been received.

19. A network element according to claim 18, wherein said network element is a base transceiver station or a radio network controller or base station controller.
